(19) United States
(12) Patent Application Publication
(10) Pub. No.: US 2013/0299250 A1
(43) Pub. Date: Nov. 14, 2013

(54) FORCE-MEASURING CELL WITH A FORCE-COMPENSATING COIL

(71) Applicant: Mettler-Toledo AG, Greifensee (CH)

(72) Inventors: Stephan Baltisberger, Gossau (CH); Andreas Metzger, Mannedorf (CH); Thomas Koeppel, Oetwil am See (CH)

(21) Appl. No.: 13/940,991

(22) Filed: Jul. 12, 2013

Related U.S. Application Data
(63) Continuation of application No. 12/038,997, filed on Feb. 28, 2008.

(30) Foreign Application Priority Data
Mar. 5, 2007 (EP) 07103513.3

(51) Int. Cl. G01G 7/02

(52) U.S. Cl. CPC G01G 7/02
USPC 177/210 EM

(57) ABSTRACT

A multi-layered electromagnetic coil for a force-measuring system is based upon the principle of electromagnetic force compensation, as is a method for manufacturing the coil. The coil has a multifilar, specifically bifilar, wiring arrangement of coil wires. Preferably, the coil wires have a substantially rectangular cross-sectional profile. The cross-sectional profile of the coil wire is designed for achieving the densest possible packing of the windings in the coil can be achieved.

### CROSS-REFERENCE TO RELATED APPLICATIONS

This application is a continuation of U.S. Ser. No. 12/038,997, filed 28 Feb. 2008 and now abandoned, which in turn claims a right of priority under 35 USC §119 from European patent application 07103513.3, filed 5 Mar. 2007. The content of both applications is incorporated by reference as if fully recited herein.

### TECHNICAL FIELD

The present invention relates to a force-measuring system, based on the principle of electromagnetic force compensation, having a multi-layered electromagnetic coil, and to a method of manufacturing the coil.

### BACKGROUND OF THE ART

The electromagnetic coil is suitable for a force-measuring system of the type described in commonly-owned U.S. Pat. No. 6,326,562 B1, to Burkhard, et al, which is based on the principle of electromagnetic force compensation and finds application for example in the field of weighing technology.

This force-measuring device contains a force-transmitting device which includes a parallel-guiding mechanism and often a lever mechanism for the reduction of a force that is to be transmitted, for example a weighing load. The electromagnetic coil, which is movable in a magnetic field and through which a current can be conducted, is arranged on the output side of the lever mechanism.

The force that is acting on the coil by way of the lever mechanism causes the coil to change its position, whereupon the change is detected by a position transducer, specifically an optical position sensor. In response to the position change, the flow of current in the coil is changed until the coil returns to its original position. Accordingly, the electromagnetic coil produces a counterforce which counteracts the force transmitted by the lever mechanism and which is referred to as compensation force. The change in the current to produce the compensation force, the so-called compensation current, represents a measure for the force that is to be measured with the force-measuring cell. This measurement principle is referred to as electromagnetic force compensation.

The magnetic field is produced by means of a permanent magnet with an air gap, and the coil is immersed in the electromagnetic field in the air gap. If a lever mechanism is present in the arrangement, the coil is preferably attached to the longer lever arm of the last lever.

The electromagnetic coil consists of one or more windings of an electrically conductive and insulated coil wire. The electrically conductive part of the coil wire typically consists of a metallic wire, for example a copper wire or an aluminum wire, and the insulating part consists of a layer of insulating material, for example a baked-on lacquer, which forms a coat around the conductive part. An electrical insulation of the coil wire is necessary in order to avoid electrical contact between adjacent coil windings. The coil is often wound on a carrier body that lends the required rigidity to the windings. However, there are also so-called air coils which are held in their shape by an adhesive compound that bonds the windings to each other.

Force-measuring systems with electromagnetic force compensation have the drawback that the power loss (heat dissipation) of the coil is load-dependent, varying with the compensation current. Thus, when weighing different loads one after another, different amounts of dissipated heat are released for each load, with the amount of dissipated power being in proportion to the square of the current. As described, for example, in U.S. Pat. No. 4,134,468, to Lüchinger, an undesirable instability of the zero point and in some cases of the sensitivity occurs as a result of the continuously changing temperature in the system.

This phenomenon gets particularly disturbing if one attempts to increase the resolution of balances of a compact design, which among other things entails using the permanent magnet system to the maximum of its capability. If the balances have a lever-reduction mechanism, the sensitivity is affected by temperature differences which occur in the lever. In order to produce force-measuring systems of high accuracy, it is desirable to keep the influence factors that enter into the measurement as constant as possible.

As a mechanism for the temperature compensation a so-called push-pull system for the electromagnetic force compensation is known from the existing state of the art. With this system, the resultant compensation force is composed of force components which counteract each other and which hold the coil in a state of equilibrium.

These mutually opposed force components can be generated through a bifilar winding arrangement of the coil, wherein two anti-parallel flows of electric current are conducted through the coil windings. With an appropriate choice of the currents, the amounts of the two opposing force components can be regulated so that the pushing force counterbalances the pulling force in such a way that the desired compensation force is obtained.

Due to the fact that the total power loss of the coil is the sum of the power losses of the two individual, mutually opposed currents, the load-dependent temperature fluctuations are significantly reduced. Furthermore, for small loads the coil can be operated in the range of optimal linearity.

For a bifilar winding, two insulated coil wires are in most cases wound in parallel and simultaneously onto a coil. This has the advantage that the two coil wires can be placed in nearly identical spatial arrangements, which has the result that the power loss is distributed uniformly and the mutually opposed force components are to a large extent symmetric.

A further requirement imposed on a coil for a force-measuring system, in particular for a force-measuring system of high resolution, is to dimension the coil in a way that maximizes the utilization of the available space. The degree of utilization is characterized by the fill ratio, i.e. the ratio between the volume of the conductive material, for example copper, and the maximally available space. The fill ratio can vary strongly depending on how the coil is wired, i.e. depending on the characteristics and arrangement of the windings.

Within the present context, the general arrangement of one or more coil wires to make up a coil is referred to as the wiring of the coil, while the term “winding” refers to the physical wrapping of a coil wire around a center. Such a winding center is also defined in the case of windings around cornered edges.

An important factor in optimizing the fill ratio is the thickness of the insulating layer of the coil wires. In order to achieve a high fill ratio, one has to aim for the thinnest possible insulating layer which, however, needs to be sufficiently insulating and stress-tolerant.

If the insulating layer is overstressed, cracks and fractures occur which can lead to leakage currents and/or short circuits between the individual windings. These leakage currents flow from a winding through the areas of impaired insulation to the neighboring winding if there is a difference in the voltage potential between the windings. The leakage currents are generally not contributing to the generation of the compensation force and thus lead to a spatially non-uniform distribution of the compensation effect and thus to a reduced efficiency of the coil.

Furthermore, the fill ratio of a coil is reduced by unused gaps. These gaps occur typically in the form of air-filled hollow spaces between the individual windings of the coil wire and in some cases between the windings and the elements that delimit the coil. The fewer gaps a coil has, the higher is in general the fill ratio.

It is known that a better fill ratio is achieved with an ordered arrangement of the windings of the coil wire than with an uncontrolled arrangement of the windings. Coils with a high fill ratio therefore have in most cases a layered structure in which the individual windings of a layer are arranged adjacent to each other. The occurrence of unused gaps between the individual windings is thereby significantly reduced.

In the wiring of a coil a distinction is made between edgewise wiring and flatwise wiring. In the case of a cylindrical coil with edgewise wiring, adjacent windings lie next to each other in the radial direction, and the layers are arranged above one another in the axial direction. Conversely, with flatwise wiring adjacent windings lie next to each other in the axial direction, and the layers are arranged above one another in the radial direction. This also applies analogously to non-cylindrical, for example quadratic, coils. The following remarks on the optimization of the fill ratio apply equally to both kinds of coil wiring.

Besides the layer structure, it is known that the fill ratio of a multi-layered coil can be further optimized with an advantageous arrangement of the windings within a layer. The aim is therefore that between neighboring layers, the windings of the upper layer are arranged as much as possible in such a way that they lie in the furrows or grooves of the lower layer. The furrows occur typically between adjacent windings of the lower layer.

However, this preferred arrangement of the windings cannot be carried through for the entire wiring of the coil. With the layered wiring it is unavoidable that the windings of the lower layer and the windings of the layer immediately above it intersect or cross over each other. These crossovers are the result of the geometric property whereby the windings of the individual layers form helix spirals with opposite orientations between neighboring layers. Unavoidably, these crossovers cause local irregularities which cause individual coil wires of the individual windings to be spaced farther apart and therefore set a limit on the achievable fill ratio.

There are further limitations which make it necessary to deviate from the preferred arrangement of the windings. For example in the border zones of the coil, i.e. at the transition from a lower layer of the windings to the next layer above, irregularities in the arrangement of the windings cannot be avoided. However, these irregularities are typically of secondary importance and are dropped from consideration hereinafter.

In the aforementioned crossovers, the coil wires of the upper layer change their position at the points where they pass from one furrow of the lower layer to the next. As a result, narrow bending radii occur at these locations, leading to commensurately high local stresses in the insulation coating. In the manufacturing process of the coil, particular care needs to be taken to align the wire so precisely at these transitions that neither unnecessary gaps nor excessive stresses occur in the insulation coating as a result of narrow bending radii and shear forces.

In coils with a high fill ratio, conditions that lead to high stresses in the insulation coating are on the one hand to be avoided. On the other hand, in order to achieve a tightly packed wiring of the coil the windings need to be wrapped around the coil with a certain not too moderate amount of tension. Therefore, highly developed and expensive mechanisms are typically used to regulate the wire tension and to control the advancing and guiding of the wire during the wiring process.

In the manufacturing process of coils with a high fill ratio and with multifilar wiring arrangements, the problems of gaps between the windings and stresses in the insulation coating occur with increased severity. In this case, for each turn around the coil two or more coil wires of the lower layer are crossed by two or more coil wires of the upper layer. As a result, there are more crossings and, in addition to the smaller bending radii, a larger number of contact points between the respective windings of the upper layer and the lower layer, so that the insulation coating is exposed to a commensurately greater stress load.

Due to the larger number of gaps, the larger differences between the voltage potentials of the windings, and the greater stress loads on the insulation coating, coils with at least bifilar wiring are more susceptible to leakage currents than monofilar coils.

In coils with multifilar wiring, the fill ratio is reduced in comparison to a monofilar wiring arrangement due to the larger number of irregularities and the unused gaps associated with them. Furthermore, the useful operating life and/or the efficiency of the coil may be compromised by the higher stress load of the insulation coating. In addition, the simultaneous manipulation of several coil wires makes the manufacturing process more complicated than in a coil with monofilar wiring.

The present invention therefore has the objective to propose a multi-layered electromagnetic coil with a multifilar, specifically bifilar, wiring arrangement of the coil wires, which offers an improved fill ratio for a force-measuring system that is based on the principle of electromagnetic force compensation. The structure of the coil and its manufacturing process should be such that no excessive stress loads occur in the insulation coating. A further objective is to propose a simple method for the manufacture of such a coil.

### SUMMARY OF THE INVENTION

The foregoing objectives are met by an electromagnetic coil and by a manufacturing method with the features described, respectively, in the independent apparatus claim and in the independent method claim. Advantageous developments of the invention are presented in further claims.

In the multi-layered electromagnetic coil according to the invention which is part of a force-measuring system based on the principle of electromagnetic force compensation and which contains a multifilar, specifically bifilar, arrangement of coil wires, the coil wires have an essentially rectangular cross-section.

This solution has the advantage that due to the approximately rectangular cross-sectional wire profile a high fill ratio can be achieved. Since the windings in an upper layer can be arranged largely unaffected by the winding arrangement of the layer below it, there will be no irregularities except for those of negligible importance in the end zones of a coil. Even with the multiple crossovers of the kind that have a particularly strong effect in multifilar and specifically in bifilar wiring arrangements, the available space is being used effectively and the fill ratio is thus increased.

By avoiding the occurrence of gaps one further gains an advantageous improvement in regard to the dependence of the measuring system from ambient influence factors. There are conditions, for example in a room with high humidity, where moisture from the ambient air will penetrate into the gaps in the coil. This causes on the one hand a weight change of the coil over time and thus a drift of the zero point of the measuring scale. On the other hand, the humidity favors the occurrence of leakage currents, which leads to changes of the compensation force.

The problem of leakage currents exists to a particularly high degree in coils with multifilar and specifically in bifilar wiring, because with the electrical currents flowing antiparallel to each other in opposite directions, the differences in the electrical potentials between adjacent windings are particularly large. Thus, the moisture in the gaps and the large differences between the electrical potentials both have an unfavorable effect. A reduction of the gaps is therefore particularly advantageous in coils with multifilar and bifilar wiring.

Furthermore, the rectangular cross-sectional profile of the coil wires has great advantages in regard to the stress load of the insulation coating. Since the areas of contact between the windings of adjacent layers are primarily in the nature of distributed surface contacts, no excessive localized stresses can occur in the insulation coating except in the end zones of a coil where they can be disregarded. The occurrence of damages which can compromise the long-term stability and efficiency of the coil as described above are thereby effectively avoided.

The manufacturing process of the coil is significantly less complicated with coil wires of essentially rectangular cross-sectional profile. As the windings of an upper layer can be arranged largely unaffected by the arrangement of the windings of the adjacent layer below, there is no complicated changeover from one furrow to another except in the end zones which can be disregarded, obviating the need for extensive control- and regulation mechanisms. Except for the end zones, the coil wire can be wound in the same way as in a coil with a single layer of windings.

An advantageous design for the cross-sectional profile of the coil wires consists substantially of a rounded rectangular shape. This shape has the advantage that a non-uniform coating thickness of the insulation coating in the vicinity of the edges can be avoided. Such shapes can be obtained from a raw material of any desired shape by pulling the material through a wire-drawing die, or from an originally round coil wire through suitable processes such as rolling or pressing. Furthermore, with the rounded shape one can avoid causing damage to the insulation coating during the manufacturing process of the coil. In particular shear forces between adjacent windings are avoided or at least reduced.

If the shorter sides of the profile of the coil wire are of a biconvex shape, the manufacturing process is simplified, similar to the rectangular shape with rounded edges. Likewise, with a flattened shape of the longer sides very even, compact layers of windings can be produced.

If the ratio between length and width for the rectangular profile shape is more than 1.2, and in particular more than 1.5, the coil can be produced without expensive wire-guiding mechanisms. Otherwise, there is a risk that the coil wire will become twisted during the coil-winding process, so that larger irregularities will occur in the wiring, causing more severe stress loads in the insulation coating.

The coil wires can also be arranged so that each of the coil wires forms, respectively, a complete layer of the coil. Except for unavoidable irregularities in the end zones, it is possible to produce a very regular, stratified structure of the layers with this concept.

In an advantageous embodiment of the invention, the coil wires of the multifilar, in particular bifilar, wiring arrangement are brought together into a wire combination. This offers the advantage that a better homogeneity and equivalence in regard to the generation of compensation forces can be realized. In particular, the two opposing force components in a push-pull system are thereby symmetrically matched to each other. Furthermore, the manufacturing process is simplified, because the combined coil wires can be processed in a simple way.

The wire combination can be formed by arranging the longer sides of the rectangular coil wire profiles adjacent to each other. In this way, it is possible to achieve a compact and stable wire combination by laying prefabricated flattened coil wires on top of each other.

On the other hand, the wire combination can also be formed by arranging the shorter sides of the rectangular coil wire profiles adjacent to each other. This allows a simple manufacturing process for the wire combination from round or square coil wires without requiring major shaping processes. In addition, this leads only to small stress loads in the insulation coating.

In one embodiment of the invention, the coil wires are joined together in a wire combination, in particular bonded by an adhesive. Deviations from the optimal, i.e. parallel, arrangement are thereby largely avoided. Such deviations can occur for example in the manufacturing process of the coil, in particular at the end zones.

The adhesive bonding can be achieved in different ways, for example through an insulation material in which an adhesive property is activated in the presence of pressure and/or heat, or through the action of a solvent on the insulation layer or on an additional coating layer of the coil wires which causes an adhesive bonding and/or welding of the coating layers, or by infusing an additional adhesive agent between the coil wires.

The advantages that are gained from the shaping of the individual coil wires can be realized analogously for the wire combination in that the cross-sectional profile of the wire combination has an essentially rectangular shape which may be rounded, whose length/width ratio is more than 1.2, in particular more than 1.5, and/or whose shorter sides are curved to form a biconvex or double-biconvex contour and/or whose longer sides are flattened.

In the arrangement of the coil wires according to a further embodiment, in a layer formed of windings of the wire combination, a first coil wire of the wire combination is always arranged closer to the center of the winding. In this way a consistent layer structure is obtained in the coil and thus a high fill ratio, even allowing for the possibility that there are differences in the shapes of the two coil wires. A uniform structure can be achieved in particular if the afore-described arrangement of the coil wires is used in every layer.

In a wiring arrangement according to a further advantageous embodiment, a wire combination that has two coil wires is wound in such a way that alternating between layers, in a first layer the first coil wire is closer to the center and in the next-following layer the second coil wire is closer to the center of the winding. Asymmetries in the arrangement of the two coil wires can thereby be avoided.

The coil according to a further embodiment can be designed as an air core coil, in particular of cylindrical shape and in particular with at least eight layers. The advantages gained with the configuration of the coil wires according to the invention manifest themselves all the more strongly, the greater the number of layers that a coil has. While with the coil wire profile according to the known state of the art, the irregularities repeat themselves from one layer to the next, with the coil wire profile according to the invention the layers and thus the irregularities are largely independent of each other.

The coil according to the invention is preferably manufactured in a process in which the coil wires and/or the wire combination are formed under pressure and/or heat, possibly in a step that immediately precedes the winding operation. This results in a precise control over the shape.

The coil wires, which in some cases may have been prefabricated in a rectangular shape, can also be spooled off from several drums whose axes are oriented essentially parallel to the axis of the windings of the coil that is to be produced. This prevents the coil wires and/or wire combination from becoming twisted.

It is further possible that the manufacturing process includes a step in which the coil wires are joined together into a wire combination and wound onto a drum. The axis of the drum is preferably oriented parallel to the axis of the windings of the coil that is to be produced. This prevents the preassembled wire combination from becoming twisted in the intermediate storing phase.

In the process of winding the coil, the tensile force exerted by the coil wires and/or by the wire combination on the coil that is to be produced is regulated according to prescribed values, whereby a tightly packed wiring of the coil is achieved with a small stress load on the insulation coating.

### BRIEF DESCRIPTION OF THE DRAWINGS

Details of the method and apparatus according to the invention are presented in the description of the examples of embodiments which are shown in a very schematic form of representation in the drawings, wherein:

FIG. 1 is a sectional view showing the concept of a force-measuring cell based on the principle of electromagnetic force compensation;

FIGS. 2a through 2c show coils as used preferably in force-measuring cells according to FIG. 1, with FIG. 2a showing a perspective view of a coil that is wound on a carrier bobbin, FIG. 2b showing a perspective view of a coil that is configured as an air coil, and FIG. 2c showing a sectional view along the line I-I of FIG. 2a;

FIGS. 3a through 3c show sectional views of a coil with bifilar wiring analogous to FIG. 2c, with coil wires shaped according to the invention and arranged in different ways, that is, in parallel-paired windings in FIG. 3a, with a layer structure in FIG. 3b, or combined into a wire pair in FIG. 3c;

FIGS. 4a through 4d show sectional views of different forms of the wire combination, with FIG. 4a showing the individual coil wires having a substantially rectangular shape and joined together at the long sides of the rectangles; with FIG. 4b showing an analogous configuration to FIG. 4a, but with a rounded rectangular shape of the individual coil wires and a length/width ratio of more than 1.5 for the wire combination; with FIG. 4c showing a configuration analogous to FIG. 4a, but with biconvex shorter sides and flattened longer sides; and with FIG. 4d showing individual coil wires with a rectangular shape that are joined together along a short side of the rectangle;

FIGS. 5a through 5c showing a detailed sectional view analogous to FIG. 3a, with further wire-combination arrangements according to the invention, with FIG. 5a showing a general layered structure, with FIG. 5b showing a layered structure with equal orientations of the layers, and with FIG. 5c showing a layered structure with alternating orientations of the layers;

FIG. 6 shows the principle of a device for the joining of the coil wires and the shaping of the wire combination; and

FIGS. 7a through 7b show the principle of the manufacturing process of the coil and the feeding of the coil wire by spooling the wires off from drums, with FIG. 7a depicting an embodiment having vertically oriented drum axes, with shaping rollers for the shaping of the wire combination, with a device for intermediate storage of the wire combination, and a device for regulating the tension; and with FIG. 7b depicting an embodiment with horizontally oriented drum axes and shaping rollers for the shaping of the individual coil wires.

### DETAILED DESCRIPTION OF A PREFERRED EMBODIMENT

FIG. 1 represents a strongly simplified schematic view of a force-measuring cell 1 which is based on the principle of electromagnetic force compensation and is suitable for use in the field of weighing technology. The force-measuring cell 1 includes a force-transmitting device with a parallel-guiding mechanism that has a stationary part 2 and a vertically movable part 3 which are pivotably connected to each other through flexure pivots 5 at the ends of a pair of guide members 4. The vertically movable part 3 has a cantilevered portion 15 serving to receive a load that is to be measured. The normal component of the force generated by a load is transmitted from the vertically movable part 3 through a coupling element 9 to the short lever arm 8 of the lever 6. The lever 6 is supported on a portion of the stationary part 2 by means of a flexure fulcrum 7. The force-measuring cell further includes a cup-shaped permanent magnet system 10 which is arranged in fixed connection with the stationary part 2 and includes an air gap 11. Arranged in the air gap 11 is a coil 13 which is connected to the longer lever arm 12 of the lever 6. A compensation current I_{cmp} of a magnitude that depends on the force acting on the lever 6 flows through the coil 13. The position of the lever 6 is measured by an opto-electronic measuring device 14 connected to a regulating device which in response to the measuring signals received regulates the compensation current I_{cmp} in such a way that the lever 6 is always held in the same position or returned to said same position after a change in the load has occurred.

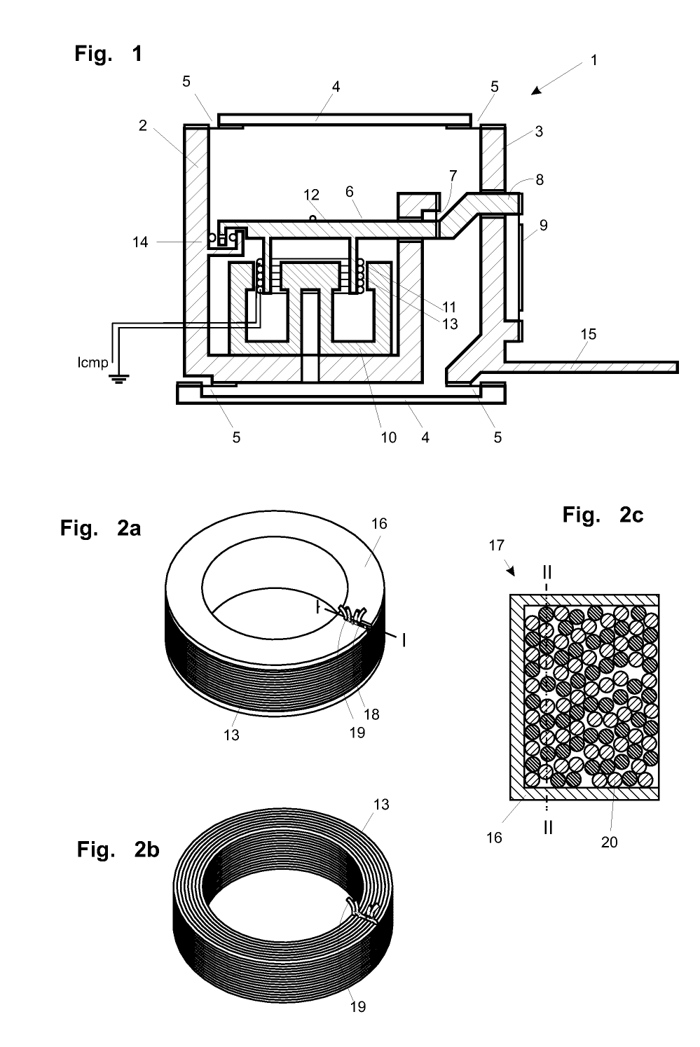

FIG. 2a shows a coil 13 according to the existing state of the art of the kind which is used with preference in force-measuring cells according to FIG. 1. The coil 13 is arranged on a toroid-shaped bobbin 16 wherein only the opening 18 for the passage of the lead wires 19 to the coil 13 is not encapsulated. A coil bobbin 16 of this kind consists preferably of a non-magnetic material such as for example a polymer, copper or aluminum.

A further embodiment in the form of an air coil is shown in FIG. 2b. The coil 13 in this case has no supporting bobbin core 16, but the windings of the coil are kept together in their shape by an adhesive compound.

FIG. 2c represents a sectional view of the coil arrangement 17 along the line I-I with a bifilar arrangement of coil wires of the kind used in the existing state of the art. The windings 20 form individual layers that lie above one another. As an example, the arrangement of a layer is indicated by the broken line II-II. The larger gaps between the windings 20 occur as a result of irregularities of the windings 20, in particular at crossovers of the windings 20 and in the end zones of the carrier bobbin 16.

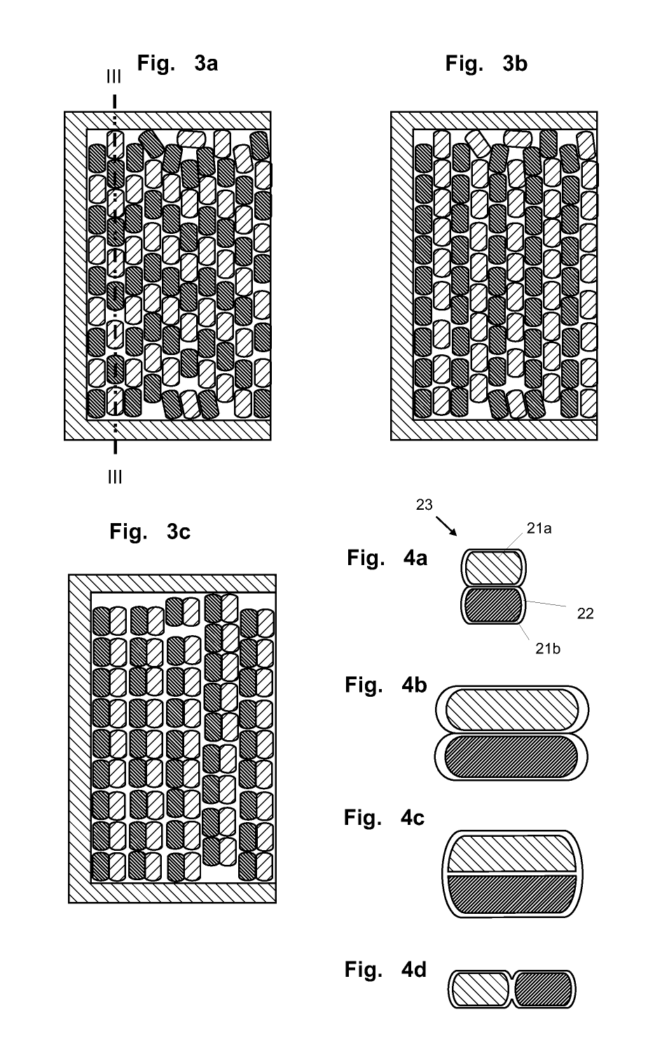

FIG. 3a illustrates, in sectional view, a coil arrangement 17 with a bifilar arrangement of the coil wires which are shaped in accordance with the invention. Typically, the coil wires 21a and 21b which are in essence rectangular-shaped are wound side-by-side, one layer after another. The lightly hatched areas represent the first coil wire 21a, while the densely hatched areas indicate the second coil wire 21b. Except for the end zones, it is possible in this manner to achieve very uniformly structured layers, as indicated by the broken line III-III. The insulation coating which envelops each of the coil wires is not shown, although the feature is seen in FIG. 4a as reference number 22. According to FIG. 3a, the coil wires are guided side-by-side during the winding process, meaning that the shorter sides of the rectangular cross-sectional profiles are next to each other. FIG. 3b illustrates an arrangement in which the coil wires during the wiring process are trained in such a way that each of the coil wires forms in essence a complete layer of the coil. FIG. 3c shows a sectional view of a coil with a bifilar wiring arrangement analogous to FIG. 2c, with coil wires shaped according to the invention and arranged in a way that is combined into a wire pair.

FIG. 4a represents a sectional view of a wire combination of the kind used in FIG. 3c. The coil wires 21a and 21b have essentially rectangular shapes and are brought together into a wire combination 23. During the process of winding the coil, the coil wires are guided to run above each other in such a way that the longer sides of the rectangular cross-sectional profile areas lie on top of each other. The coil wires are individually encased with an insulation coating 22. In case that the coil wires are to be joined together permanently, the insulation coating 22 itself or a further adhesive compound can take on the function of the connecting means.

A situation analogous to FIG. 4a is shown in FIG. 4b, however essentially with a rounded rectangular shape of the individual coil wires and a length/width ratio of more than 1.5 for the wire combination.

Also analogous to FIG. 4a, FIG. 4c shows an essentially rectangular shape of the wire combination with biconvex shorter sides and flattened longer sides.

A further analogous situation to FIG. 4a is shown in FIG. 4d; however the individual coil wires are joined together into a wire combination at the shorter sides of their rectangular cross-sectional profiles.

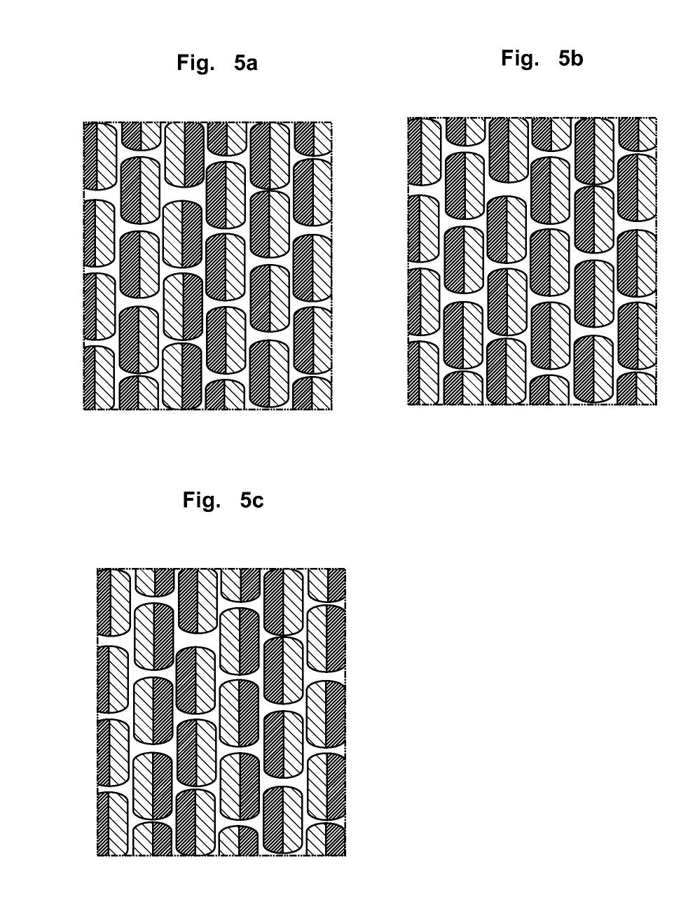

FIG. 5a represents a detail of a cross-sectional view analogous to the situation in FIG. 3a, wherein however the coil wires 21a and 21b are joined together into a wire combination 21 according to FIG. 4c. As in FIGS. 3a-3c, the insulation coating layer is not shown. With this arrangement, one of the coil wires 21a or 21b is always arranged closer to the center of the windings, so that a distinct layer structure is obtained.

FIG. 5b shows an arrangement similar to FIG. 5a, but in this case the same one of the two coil wires 21a and 21b forms the windings that are closer to the center in every one of the layers.

FIG. 5c is similar to FIG. 5a, but in this case the two coil wires 21a and 21b alternate from layer to layer in occupying the layer that is closer to the center.

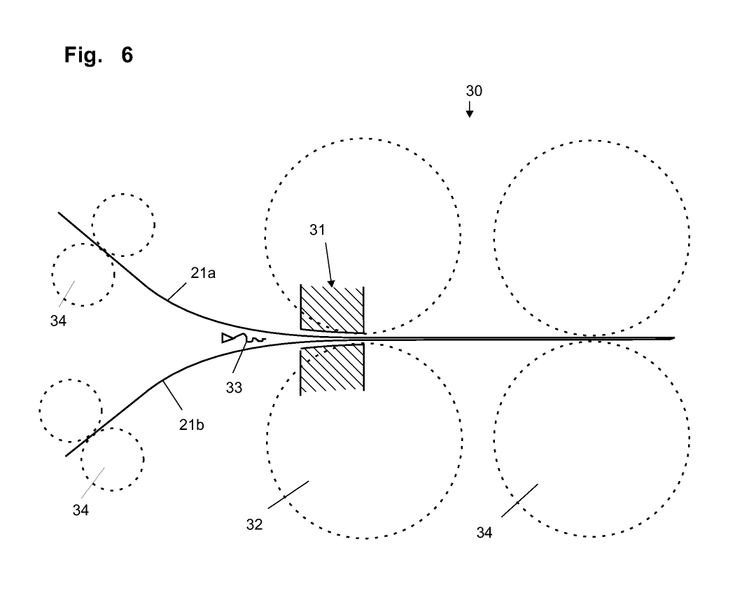

FIG. 6 represents in a very schematic way a device for producing a wire combination 30 in which the two coil wires 21a and 21b can be joined together. The joining can be controlled by a mechanical guide 31 which is shown schematically in a sectional view. However, the manufacturing device for a wire combination can also be realized in the form of rollers 32 as indicated by broken lines. A joining agent 33 can be injected between the coil wires 21a and 21b immediately before they are joined together. However, it is also possible to inject a solvent to superficially dissolve the insulation layer of the coil wires or a special adhesive coating that encases the coil wires. Downstream of the joining, a device 34 such as for example two opposing rollers is arranged which serves to shape the cross-sectional profile of the wire combination 23. However, this device can also be incorporated in the mechanical guide 31 or in the rollers 32. The individual coil wires 21a and 21b can be shaped partially or completely by means of the shaping rollers 34. This shaping process can be performed immediately before the joining, but it can also be incorporated into the processes performed by the manufacturing device for the wire combination 30.

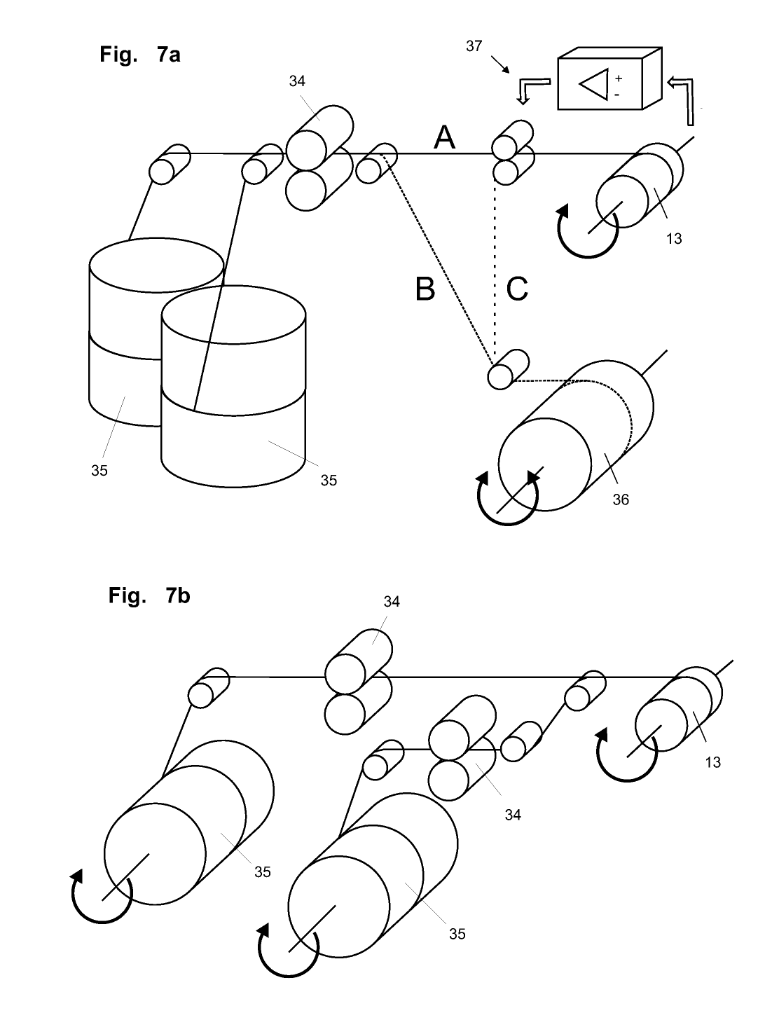

A very schematic view of a device for the manufacture of the coil is presented in FIG. 7a. The coil wires are in this case pulled from vertically standing drums 35 and—after passing through a manufacturing apparatus for a wire combination 30—either follow path A to be wound onto the coil 13 that is to be produced, or path B to be wound onto the horizontally oriented rotatable drum 36. After an intermediate storage phase on the drum 36, the wire combination 23 can at a given time be pulled along path C to be wound onto the coil 13 that is to be produced. The tensile force which in the wiring process acts on the coil to be produced can be regulated to a given amount by a regulating device 37.

In the arrangement according to FIG. 7b, the axes of the drums 35 are oriented horizontally and thus parallel to the axis of the coil 13 to be produced. In this way, it is possible to wind partially or completely prefabricated rectangular coil wires onto the coil 13 without twisting. In addition, the individual coil wires can be either completely shaped or reshaped by the shaping rollers 34. In this case the coil wires are brought together directly without pressure, heat or adhesive agent and are wound onto the coil 13.

What is claimed is:

1. A force-measuring cell, based on the principle of electromagnetic force compensation, the cell comprising:
a force-transmitting device with a parallel guiding mechanism having a stationary part and a vertically-movable part, pivotably connected to each other so that a load received by one of the parts causes relative movement of the parts;
a permanent magnet system, arranged in fixed connection with one of the parts, the permanent magnet system including an air gap;
a multi-layered electromagnetic coil, connected to the other part and arranged for movement in the air gap, the coil comprising an at least bifilar arrangement wound from a wire combination that comprises a first and a second coil wire and an insulating coating that holds the respective coil wires together in fixed position while electrically isolating the respective coil wires from each other, each of the first and second coil wires having a rectangular cross-sectional profile; and
a force compensation circuit, comprising a device that measures the position of the part connected to the electromagnetic coil and, based on the position, applies a compensation current to one of the coil wires so that the coil is held in the same position or returned to the same position after a change in the load occurs.

2. The cell of claim 1, wherein:
the cross-sectional profile is a rounded rectangular shape, with the shorter sides being formed in a biconvex shape and the longer sides being flattened.

3. The cell of claim 1, wherein:
the cross-sectional profile has a ratio of the lengths of the longer sides to the shorter sides that is at least 1.2:1.

4. The cell of claim 3, wherein:
the ratio is at least 1.5:1.

5. The cell of claim 1, wherein:
substantially each of the coil wires forms a layer of the multi-layered electromagnetic coil that is complete in itself.

6. The cell of claim 1, wherein:
the coil wires are brought together into a wire combination by arranging corresponding sides of the rectangular cross-sectional profiles of the wires adjacent to each other.

7. The cell of claim 6, wherein:
the cross-sectional profile of the wire combination is a substantially rectangular shape, with the shorter sides being formed in a double biconvex shape and the longer sides being flattened.

8. The cell of claim 7, wherein:
the cross-sectional profile has a ratio of the lengths of the longer sides to the shorter sides that is at least 1.2:1.

9. The cell of claim 8, wherein:
the ratio is at least 1.5:1.

10. The cell of claim 2, wherein:
the coil wires are brought together into a wire combination by arranging corresponding sides of the rectangular cross-sectional profiles of the wires adjacent to each other.

11. The cell of claim 4, wherein:
the coil wires are brought together into a wire combination by arranging corresponding sides of the rectangular cross-sectional profiles of the wires adjacent to each other.

12. The cell of claim 6, wherein:
the wiring combination is formed into layers of windings, with one coil wire of the bifilar arrangement arranged closer to a center of the winding in each layer thereof.

13. The cell of claim 8, wherein:
the wire combination is arranged in a way that corresponding sides of the rectangular cross-sectional profiles are in an adjacent relationship.

14. The cell of claim 6, wherein:
the wire combination is a bifilar coiled arrangement formed into layers of windings, with an arrangement of a pair of alternating layers, with one coil wire arranged closer to a center of the winding in a first set of the alternating layers and the other coil wire arranged closer to the center of the winding in the second set of alternating layers.

15. The cell of claim 1, wherein:
the multi-layered electromagnetic coil is a bifilar arrangement.

16. A force-measuring device, comprising:
a plate upon which a load is received; and
a force-measuring cell according to claim 1, wherein the plate is connected to the vertically-movable part.
